(19) United States
(12) Patent Application Publication
(10) Pub. No.: US 2017/0304664 A1
(43) Pub. Date: Oct. 26, 2017

(54) QUICK-RESPONSE SPRINKLER

(71) Applicant: OBSCHESTVO S OGRANICHENNOI OTVETSTVENNOSTJU ''FORNOSOVSKOE NAUCHNO-PROIZVODSTVENNOE PREDPRIAYT, Leningradskaya obl., (RU)

(72) Inventors: Leonid Timofeevich TANKLEVSKI, St.Petersburg (RU); Mikhail Aleksandrovich VASILIEV, St.Petersburg (RU); Alexandr Valerevich ARAKCHEEV, St.Petersburg (RU)

(21) Appl. No.: 15/513,153

(22) PCT Filed: Jul. 29, 2015
(86) PCT No.: PCT/RU2015/000474

§ 371 Date: Mar. 21, 2017

(30) Foreign Application Priority Data
Sep. 22, 2014 (RU) 2014138307

(51) Int. Cl. A62C 37/11; A62C 37/40

(52) U.S. Cl. CPC A62C 37/11; A62C 37/40

(57) ABSTRACT

The invention relates to fire-extinguishing means, and more particularly to sprinklers for fire-extinguishing systems. A sprinkler comprises a body with an outlet opening which is closed off by a check valve, and a unit for controlling the state of the check valve. The sprinkler is provided with a fire sensor and an activation unit. The unit for controlling the state of the check valve is equipped with an electric trigger device. The input pins of the activation unit are connected to the outputs of the fire sensor. The output pins of the activation unit are connected to the outputs of the electric trigger. The technical result is an increase in the response speed of the sprinkler.

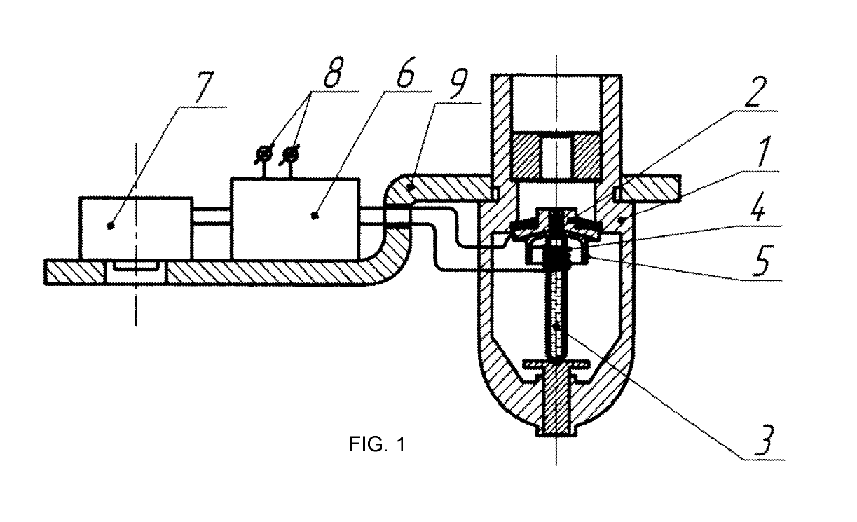

### CROSS-REFERENCE TO RELATED APPPLICATION

This application claims priority to PCT application no. PCT/RU2015/000474 filed on Jul. 29, 2015. The earliest priority date claimed is Sep. 22, 2014.

### FEDERALLY SPONSORED RESEARCH

Not Applicable

### SEQUENCE LISTING OR PROGRAM

Not Applicable

### BACKGROUND

The proposed technical solution relates to fire-extinguishing sprinklers and designated to supply a fire-extinguishing product in case of fire.

The prototype of the technical solution is a sprinkler (patent for prototype Russian Federation No. 79435 “Sprinkler”).

A known device consists of the housing, shutoff valve connected to the fire sensor designed as an airtight glass flask, filled with a special liquid. The known device activates when fire sensor is destroyed due to thermal flow emitted by fire. A deficiency of this prototype is its slow acting.

A deficiency of this prototype is known for its high response time at an initial stage of fire. At the initial stage of fire, the thermal flow from the fire source has a low value and it takes a longer time to heat and destroy the sprinkler's fire sensor.

The purpose of the proposed technical solution is to make the sprinkler more fast-acting.

### SUMMARY

The proposed technical solution consists of a sprinkler, containing a housing with an outlet orifice covered by a shutoff valve, shutoff valve control, fire sensor, which controls an area protected by the sprinkler and an activation unit.

Furthermore, the shutoff valve control is equipped with an electric trigger device, while outlets are connected with electric trigger outlets.

Preferable sprinkler design options:
The control unit contains a fire sensor and an electric heater as an electric trigger device.
A differential thermal fire alarm as a fire sensor, controlling an area protected by the sprinkler;
A directional fire alarm as a fire sensor, controlling an area protected by the sprinkler;
A directional flame detector as a fire alarm;
A fire sensor, controlling area protected by the sprinkler, designed with a removable sensor;
An activation unit is placed within the fire sensor housing, controlling an area protected by the sprinkler;
the sprinkler is also equipped with a bracket to which a fire sensor is fastened, which controls an area protected by the sprinkler, as well as equipped with an activation unit;
An activation unit is equipped with additional outlets to connect with electric trigger devices of neighboring sprinklers;
A fire sensor, controlling an area protected by the sprinkler, connected to the activation unit by a receiver and controller.

### DESCRIPTION

The distinguishing features of the proposed technical solution are:
1. The sprinkler is also equipped with a fire sensor, controlling an area protected by the sprinkler, and an activation unit—feature 1.
2. A shutoff valve controller equipped with an electric trigger device—feature 2.
3. An activation unit with fire sensor inputs, and outlets connected to electric trigger outlets—feature 3
4. The controller contains a fire sensor, while an electric heater is used as an electric trigger device—feature 4.
5. A differential fire alarm as a fire sensor, controlling an area protected by the sprinkler—feature 5.
6. A directional fire alarm, as a fire sensor, controlling an area protected by the sprinkler—feature 6.
7. A directional flame detector as a fire alarm—feature 7.
8. A fire sensor, controlling an area protected by the sprinkler, designed with a removable sensor—feature 8.
9. An activation unit located within the fire sensor housing, controlling an area protected by the sprinkler—feature 9.
10. The sprinkler is also equipped with a bracket to which a fire sensor is fastened, which controls an area protected by the sprinkler, as well as equipped with an activation unit—feature 10.
11. An activation unit is equipped with additional outlets to connect with electric trigger devices of neighboring sprinklers—feature 11.
12. A fire sensor, controlling an area protected by the sprinkler, connected to the activation unit by a receiver and controller—feature 12.

The proposed technical solution purpose is the following: To equip the sprinkler with a fire sensor, controlling an area protected by the sprinkler, and an activation unit (feature 1), under condition that the shutoff valve controller is equipped with an electric trigger device (feature 2) and inputs of the activation unit are connected to fire sensor output, and outputs of the activation unit are connected with an electric trigger device (feature 3), which can make the sprinkler act faster during an initial stage of fire due to an absence of a prolonged heating of a glass flask of the sprinkler, for example, in a known technical solution, for it to trigger from a thermal flow from a fire source. Speeding up the activation of the proposed sprinkler is done by a forced impact to the shutoff valve controller, when sending an alarm to it from the activation unit in case of detecting a local fire source by a fire sensor, controlling an area protected by the sprinkler. Equipping the controller with a fire sensor and using an electric heater as an electric trigger device (feature 4) simplifies the proposed sprinkler design. Using a differential thermal fire alarm as a fire sensor, controlling an area protected by the sprinkler (feature 5) makes the sprinkler react faster, since there is an ability to activate the sprinkler immediately after detecting a change in temperature in the controlled area protected by the sprinkler. Using a directional flame detector (feature 7) as a fire alarm, controlling an area protected by the sprinkler (feature 6), makes the sprinkler react faster, since there is an ability to activate the sprinkler immediately after detecting an open flame in the area protected by the sprinkler. Using a fire sensor, controlling an area protected by the sprinkler, designed with a removable sensor (feature 8) simplifies installation of components, included in the proposed sprinkler.

Using an activation unit located within the fire sensor housing, controlling an area protected by the sprinkler (feature 9) simplifies an installation of the proposed sprinkler. Equipping the sprinkler with a bracket, to which a fire sensor, controlling an area protected by the sprinkler, is fastened (feature 10), simplifies an installation of the proposed sprinkler.

Using an activation unit is equipped with additional outlets to connect with electric trigger devices of neighboring sprinklers (feature 11) allows to send an alarm to activate neighboring sprinklers for a guaranteed fire extinguishing when a fire source is detected in the sprinkler area. Communication of the fire sensor, controlling an area protected by the sprinkler, with an activation unit by the receiving controller (feature 12) allows to use a programmed activation algorithm for this and other sprinklers when fire is detected.

The submitted drawing shows a general cross-sectional view of the fast-acting sprinkler.

The sprinkler consists of the housing (1), an output orifice with a shutoff valve (2), and shutoff valve controller, designed as a glass flask (3), filled with a special liquid. An electric trigger device (4), designed as a heating element is installed around the glass flask. The heating element outputs, through the normally closed contacts (5), are connected to activation unit outputs (6). Activation unit inputs (6) are connected to fire sensor outputs (7), controlling an area protected by the sprinkler. The activation unit (6) is equipped with outputs (8) to connect with the power line and electric trigger device of this and other sprinklers. The sprinkler is equipped with a bracket (9), to which a fire sensor (7), controlling an area protected by the sprinkler, is fastened, and the activation unit (6).

The sprinkler works in a following way. When there is a fire in the area protected by the sprinkler, the fire sensor (7) sends a signal to the activation unit (6). The activation unit (6) sends a signal to the heating element (4). A quick heating and destruction of thee glass flask (3) occurs, and the sprinkler's shutoff valve (2) is opened, whereupon the fire-extinguishing product is set upon the fire source. The local fire source is extinguished in the area protected by the sprinkler due to the fire-extinguishing product sprayed from the sprinkler.

What is claimed:

1. A sprinkler, containing a housing with an outlet, covered by a shutoff valve, a shutoff valve controller, differing by having a fire sensor, controlling an area protected by the sprinkler, and an activation unit, while the shutoff valve controller is equipped with an electric trigger device, and activation unit inputs are connected with fire sensor outputs, and outputs are connected with electric trigger outputs.

2. A sprinkler per item 1, differing by having the shutoff valve controller containing a heat sensor, and an electric heater as an electric trigger device.

3. A sprinkler per item 1, differing by having a differential flame detector as a fire sensor, controlling an area protected by the sprinkler.

4. A sprinkler per item 1, differing by having a directional fire alarm as a fire sensor, controlling an area protected by the sprinkler.

5. A sprinkler per item 4, differing by having a directional flame detector as a fire alarm.

6. A sprinkler per item 1, differing by having a fire sensor, controlling an area protected by the sprinkler, designed as a removable sensor.

7. A sprinkler per item 1, differing by having a fire sensor, controlling an area protected by the sprinkler, placed within the fire sensor housing.

8. A sprinkler per item 1, differing by having a bracket, to which a fire sensor, controlling an area protected by the sprinkler, is fastened.

9. A sprinkler per item 1, differing by having an activation unit equipped with additional outputs to connect with electric trigger devices of other sprinklers.

10. A sprinkler per item 1, differing by having a fire sensor, controlling an area protected by the sprinkler, connected with an activation unit through a receiving controller.
